(19) United States
(12) Patent Application Publication
(10) Pub. No.: US 2006/0260160 A1
(43) Pub. Date: Nov. 23, 2006

(54) Real estate sign lighting system

(76) Inventor: Robert J. Herman, Minnetrista, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/221,635

(22) Filed: Sep. 8, 2005

Related U.S. Application Data
(60) Provisional application No. 60/682,489, filed on May 19, 2005.

(51) Int. Cl. G09F 1/08

(52) U.S. Cl. 40/540; 40/607.09

(57) ABSTRACT

A real estate sign lighting system for selectively illuminating a real estate sign hanging from a real estate sign post. The real estate lighting system includes a real estate hood that is secured to a horizontal bar of the real estate sign post. Bright white light emitting diodes are secured to the underside of the real estate hood and operate to illuminate the real estate sign. A housing is mountable on the real estate hood, and supports thin-filmed solar panels secured to the top side of the housing. The thin-filmed solar panels provide charging power to rechargeable batteries located within the housing. A control circuit uses input from a light sensor to selectively apply power from the rechargeable batteries to the bright white light emitting diodes.

### CROSS-REFERENCE TO RELATED APPLICATION(S)

This application claims the benefit of U.S. Provisional Application No. 60/682,489, filed May 19, 2005, entitled “Real Estate Sign Post Lighting Hood” by Robert J. Herman.

### BACKGROUND OF THE INVENTION

One of the most widely used and effective means of advertising property is a real estate sign placed in a seller's yard. A real estate sign generally includes a vertical post placed into the ground, a horizontal beam attached to the vertical post, and a sign or series of signs hung from the horizontal beam. The real estate sign provides notice to those passing by that a particular property is for sale, as well as contact information for a real estate agent or owner in charge of selling the property. Real estate signs are generally most effective when they are conspicuously located in a seller's yard, allowing a passerby to spot the sign without problem. It is also important that contact information displayed by the sign be easy to read.

Using a real estate sign as an advertising tool becomes less effective at night, when the real estate sign becomes harder to see. Illuminating the real estate sign is one solution to making the real estate sign more conspicuous, and therefore a better advertising tool, at night. However, because real estate signs are typically located in a seller's yard, there is not always a convenient source of power for lighting the real estate sign. Therefore, it would be beneficial to develop an apparatus that does not require connection to a traditional power source (electrical wall outlet) but would be capable of providing sufficient illumination for an extended period of time to a real estate sign.

### BRIEF SUMMARY OF THE INVENTION

One aspect of the present invention provides a lighting system for real estate signs. The lighting system includes a base configured to fit over a horizontal bar of a real estate sign and a housing mountable on the base. Batteries are located within the housing and are electrically connected to bright white light emitting diodes (LEDs) that are physically positioned along the base to illuminate the real estate sign, wherein the batteries supply power to the bright white LEDs. Control circuitry located within the housing is electrically connected to the batteries and selectively controls when energy is supplied from the batteries to the bright white LEDs.

In another aspect, the present invention provides an autonomous lighting system for real estate signs. The autonomous lighting system includes a real estate sign hood configured to fit over a horizontal beam of the real estate pole. A means for illuminating the real estate sign is mounted on the real estate sign hood. The system also includes a means for generating power, a means for storing power generated by the means for generating power, and means for controlling the distribution of power from the means for storing power to the means for illuminating the real estate sign. A housing mounted on the real estate sign hood encloses the means for storing power and the means for controlling distribution of power, and supports the means for generating power.

### BRIEF DESCRIPTION OF THE DRAWINGS

FIG. 1 is a perspective view of an exemplary embodiment of a real estate sign lighting unit, including a housing and hood.

FIG. 2 is a perspective view of the components housed within the housing.

FIG. 3 is a perspective view from beneath the hood of bright white light emitting diodes used to illuminate the real estate sign.

FIG. 4 is a circuit schematic of a circuit board.

### DETAILED DESCRIPTION

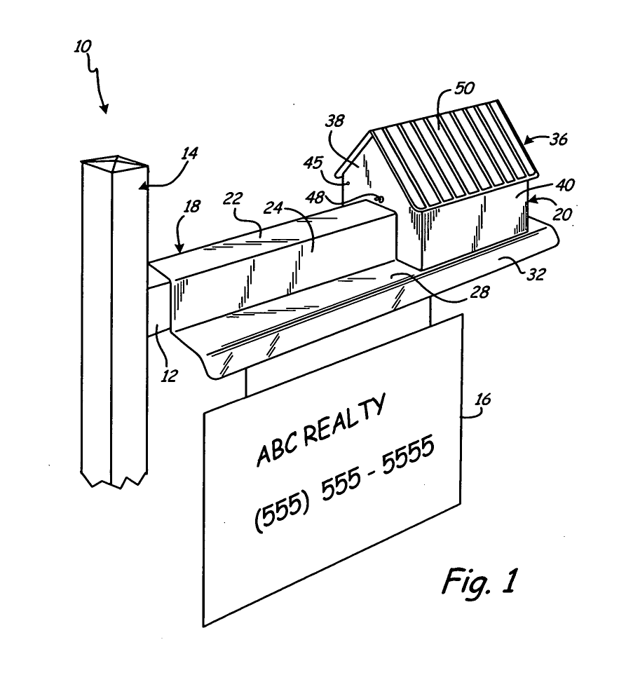

FIG. 1 is a perspective view of an embodiment of real estate sign lighting system 10, mounted on horizontal beam 12 of signpost 14. Real estate sign 16 is attached to the bottom of horizontal beam 12, and displays information regarding a particular piece of property for sale. For instance, real estate sign 16 as shown in FIG. 1 displays contact information for the real estate company (ABC Realty) selling the particular piece of property. As described in more detail below, real estate sign lighting system 10 operates to illuminate real estate sign 16 when the amount of light detected by real estate lighting system 10 is insufficient to effectively advertise the property for sale. A controller selectively applies power to bright white LEDs, turning the bright white LEDs “on” and illuminating real estate sign 16 sign for a user-designated length of time, before power is removed and the bright white LEDs are turned “off.”

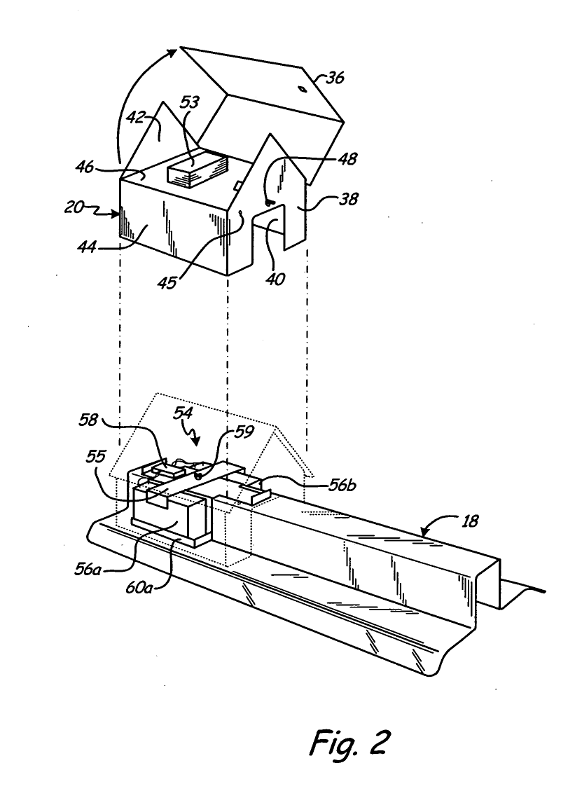

As shown in FIG. 1, real estate lighting system 10 includes hood 18 and housing 20. Hood 18 includes top 22, sides 24 and 26, platforms 28 and 30, and reflective skirts 32 and 34. In this view, side 26, platform 30, and reflective skirt 34 are obstructed and cannot be seen. Housing 20 includes a cover or roof 36, sidewalls 38, 40, 42 and 44, and floor 46 (shown in FIG. 2). Again, sidewalls 42 and 44 are obstructed in this view and cannot be seen. Mounted on sidewall 38 of housing 20 is light sensor 45, which provides input regarding the current lighting conditions to the controller located within housing 20.

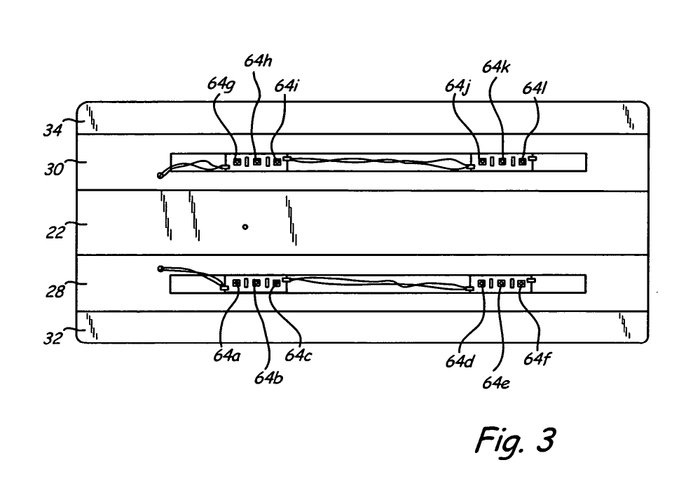

Top 22 and sides 24 and 26 of hood 18 form a rectangular shaped cavity that allows hood 18 to fit over horizontal beam 12. Platforms 28 and 30 extend away from sides 24 and 26. Bright white light emitting diodes (LEDs) (shown in FIG. 3) are secured to the bottom side of platforms 28 and 30, such that light provided by bright white LEDs illuminates real estate sign 16. Reflective skirts 32 and 34 extend away from platforms 28 and 30, respectively, and are positioned such that light generated by bright white LEDs attached to platforms 28 and 30 is reflected back towards real estate sign 16.

Housing 20 is mountable over the top of hood 18, and provides an enclosed area to store brochures (shown in FIG. 2) containing information about the particular piece of property, as well as for housing the electrical components (also shown in FIG. 2) necessary to selectively activate the bright white LEDs. Roof 36 is hinged to sidewall 40, allowing roof 36 to be lifted from the side closest to sidewall 44 to expose an interior enclosure created by the placement of sidewalls 38, 40, 42, and 44 and roof 36. Sidewall 38 and 42 are designed with a rectangular shaped opening that allows housing 20 to fit over the top of hood 18. Fastener 48 is used to secure housing 20 to hood 18.

As shown in FIG. 1, roof 36 supports solar panels 50 and 52 (located opposite solar panel 50, but obstructed in this view). By positioning solar panels 50 and 52 on top of roof 36, solar panels 50 and 52 are able to capture the maximum amount of sunlight available to real estate sign lighting system 10. Solar panels 50 and 52 convert solar energy to electrical energy, which is stored in one or more batteries located within housing 20. In one embodiment, solar panels 50 and 52 are thin-film solar panels. Solar Panels 50 and 52 are weather resistant, allowing solar panels 50 and 52 to be used in an outdoor setting exposed to the elements. For example, in one embodiment, solar panels 50 and 52 are implemented with WeatherPro PowerFilm PT15-300 solar panels. A charge controller (not shown) may also be used in conjunction with solar panels 50 and 52 to charge rechargeable batteries (shown in FIG. 2).

FIG. 2 is a perspective view of the components located within housing 20. This view shows the opposite side of housing 20, showing sidewalls 38 and 44. Floor 46, located within the enclosure of housing 20 is located perpendicular to sidewalls 38, 40, 42 and 44. Floor 46 can be used to hold brochures 53 or other informational packets pertaining the particular property for sale. Roof 36 protects the brochures from the elements, while the hinged connection of roof 36 to sidewall 40 allows passerbys to lift up roof 36 to access the brochure. The components housed within housing 20 include battery container 54, battery securing arm 55, batteries 56a and 56b, and control circuitry 58 (collectively, “the components”). When housing 20 is secured to hood 18, floor 46 rests over the components shown in FIG. 2. Therefore, if a passerby lifts roof 36, the components shown in FIG. 2 are hidden from view by floor 46. In order to gain access to these components, housing 20 must be removed from hood 18. Therefore, housing 20 protects the components from the elements as well as protects them from being tampered with by unauthorized users.

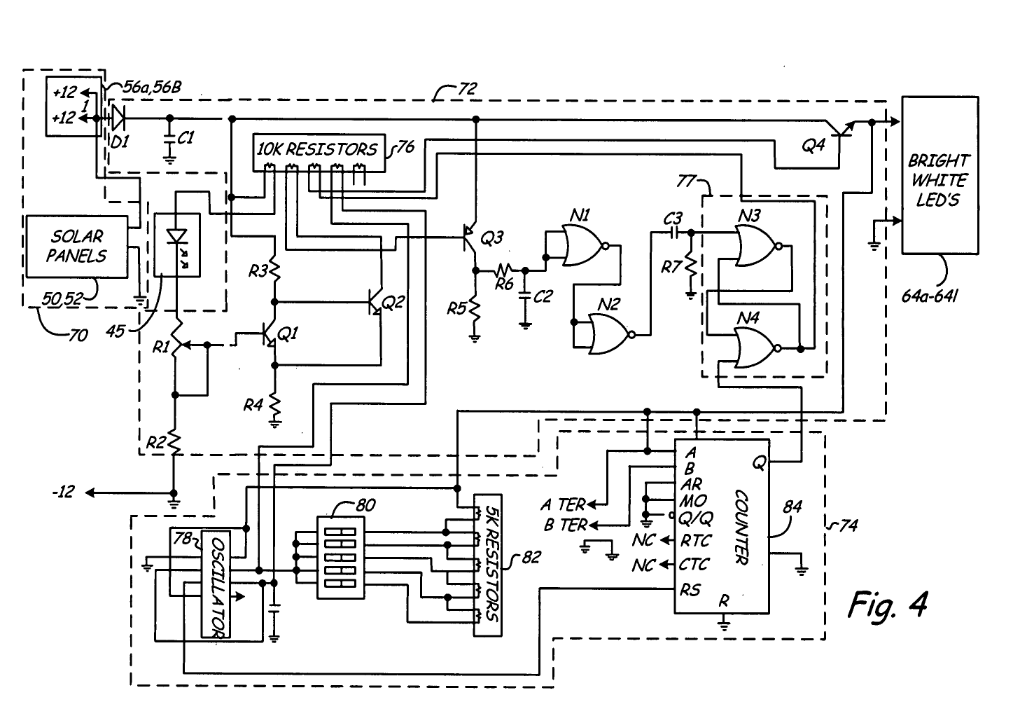

Battery container 54 is mounted to top 22 of hood 18. Fastener 59 is used to secure battery container 54 and battery securing arm 55 to top 22. Battery container 54 includes battery carriage section 60a and 60b, although only battery carriage 60a is shown in this view. When battery container 54 is secured to top 22, platforms 28 and 30 of hood 18 support battery carriage sections 60a and 60b, respectively. Batteries 56a and 56b fit within battery carriage sections 60a and 60b, respectively, and act to prevent batteries 56a and 56b from moving. Battery securing arm 55 also helps ensure that batteries 56a and 56b are held in place. In one embodiment, batteries 56a and 56b are rechargeable sealed lead-acid batteries, connected to solar panels 50 and 52. During daylight hours, batteries 56a and 56b can be charged by electrical energy produced by solar panels 50 and 52. Energy stored in batteries 56a and 56b is used to power bright white LEDs 64a-64l. Control circuitry 58 (shown in more detail in FIG. 4) is connected between batteries 56a, 56b and bright white LEDs 64a-64l. Control circuitry 58 uses input from photosensor 45 (shown in FIG. 1) to selectively allow power to flow from batteries 56a and 56b to bright white LEDs 64a-64l. Control circuitry 58 also determines how long power should be supplied to bright white LEDs 64a-64l, and operates to prevent power from flowing when that time has expired

FIG. 3 is a perspective view from beneath hood 18, illustrating the use of bright white light emitting diodes 64a-64l to illuminate real estate sign 16. As discussed in FIG. 1, hood 18 includes top 22, sides 24 and 26, platforms 28 and 30, and reflective skirts 32 and 34. Bright white LEDs 64a-64f are mounted on platform 28, with bright white LEDs 64a-64c mounted on a proximal end of platform 28 and bright white LEDs 64d-64f are mounted on a distal end of platform 28. Bright white LEDs 64g-64l are mounted on platform 30, with bright white LEDs 64g-64i mounted on a proximal end of platform 30 and bright white LEDs 64j-64l mounted on a distal end of platform 30. Bright white LEDs 64a-64l are supplied with energy from the batteries (shown in FIG. 3) located within housing 20, or in the alternative by power generated by solar panels 50 and 52. Bright white LEDs provide high luminous white light with very low energy consumption. The low energy consumption allows a fully charged battery to provide power to bright white LEDs 64a-64l for a number of hours. This is desirable because it reduces the burden on a seller or real estate agent who otherwise would need to provide new batteries each day. By using rechargeable batteries in conjunction with solar panels 50 and 52, real estate sign lighting system 10 becomes self-sufficient. A self-sufficient or autonomous system is even more desirable because it further reduces the burden on a seller or real estate agent to provide any maintenance on the system (charging or replacing batteries).

FIG. 4 is a circuit schematic of control circuitry 58, as well as the electrical components attached to control circuitry 58 (i.e., batteries 56a, 56b, solar panels 50, 52, and bright white LEDs lights 64a-64l). Control circuitry 58 includes switching circuitry 72 and timer circuitry 74. Switching circuitry 72 includes diode D1, variable resistor or potentiometer R1, resistors R2, R3, R4, R5, R6 and R7, resistor group 76 (which includes five 10k ohm resistors), transistors Q1, Q2, Q3 and Q4, capacitors C1, C2 and C3, and NOR gates N1, N2, N3 and N4 (NOR gates N3 and N4 make up SR latch 77). Timer circuitry 74 includes oscillator 78, manual switches 80, resistor group 82 (which includes five 5k ohm resistors), and counter 84.

Switching circuitry 72 is connected between power source 70 (which includes batteries 56a, 56b and solar panels 50, 52) and bright white LEDs 64a-64l. When switching circuitry 72 is in a first state, no power is allowed to flow between power source 70 and bright white LEDs 64a-64l. When switching circuitry 72 is in a second state, power is allowed to flow between power source 70 and bright white LEDs 64a-64l. The state of switching circuitry 72 is determined based on input received from photosensor 45 and timer circuitry 74. Photosensor 45 causes switching circuitry 72 to transition from the first state to the second state when light detected by photosensor 45 drops below a threshold value. This results in power source 70 providing energy to bright white LEDs 64a-64l. The exact point at which photosensor 45 causes switching circuitry 72 to transition from the first state to the second state, thus activating bright white LEDs 64a-64l, can be selected by the user by varying the resistance of variable resistor R1. As the resistance of variable resistor R1 is increased, the amount of light loss required to turn on bright white LEDs 64a-64l will decrease (i.e., the bright white LEDs will be turned on earlier in the evening). In this way, a user can determine the threshold point at which bright white LEDs 64a-64l will be activated.

Specifically, when photosensor 45 is exposed to light, it provides a low resistance path (the resistance varies inversely with the amount of light detected). When a low resistance path exists between power source 70 and transistor Q1, due to photosensor 45 being exposed to light, transistor Q1 is turned “on” (creating a low resistance path between power source 70 and ground through transistor Q1 and resistors R3 and R4. By turning transistor Q0 “on”, transistors Q2 and Q3 are turned “off”, resulting in a low voltage signal being applied to NOR gate N1. The purpose of NOR gates N1 and N2 is simply to provide a clean digital signal (either a “1” or “0” represented by high voltage level or low voltage level, respectively) to SR latch 77. The output of SR latch 77 remains low until a high voltage level is applied to NOR gate N1 (resulting in a high voltage level being applied to NOR gate N3). When the output of SR latch 77 is low, then transistor Q4 remains “off” and no power is allowed to flow from power supply 70 through transistor Q4 to bright white LEDs 64a-64l.

As the light detected by photosensor 45 decreases, the resistance of photosensor 45 begins to increase. When the resistance presented by photosensor 45 and variable resistor R1 reach a threshold level, voltage supplied by power supply 70 is no longer sufficient to keep transistor Q1 “on”, resulting in transistor Q1 being turned “off”. When transistor Q1 is turned “off”, transistors Q2 and Q3 are subsequently turned “on”, resulting in a high voltage signal being applied to NOR gate N1 (and thus NOR gate N3). A high voltage signal applied to NOR gate N1 results in the output of SR latch 77 being changed from a low voltage signal to a high voltage signal, which results in transistor Q4 being turned “on”, allowing power to flow from power source 70 to bright white LEDs 64a-64l. The output of SR latch 77 remains high until a reset signal (high voltage signal) is supplied by timer circuitry 74 to NOR gate N4. When SR latch 77 is reset, the output of SR latch 77 is a low voltage signal which results in transistor Q4 being turned “off”, preventing power from flowing between power supply 70 and bright white LEDs 64a-64l.

When transistor Q4 is turned “on”, allowing power to flow from power supply 70 to bright white LEDs 64-64l, power is also supplied from power source 70 to timer circuitry 74. In particular, power is supplied to oscillator 78, which generates an output having a frequency determined by the total resistance seen by oscillator 78, and counter 84 which counts the number of cycles generated by oscillator 78. The frequency, and therefore cycle length, of oscillator 78 can be adjusted by varying the total resistance seen by oscillator 78. Counter 84 provides a high voltage signal to NOR gate N4 when a specified number of cycles have been counted. Therefore, adjusting the resistance seen by oscillator 78 can vary the amount of time that passes before bright white LEDs are turned “off”.

As shown in FIG. 4, oscillator 78 is connected to resistor box 82 through manual switches 80, allowing a user to vary the total resistance seen by oscillator 78 by selectively opening or closing switches within manual switches 80. When counter 84 has counted a predetermined number of cycles, counter 84 sends a high voltage signal (reset signal) to SR latch 77. This results in the output of SR latch 77 to switch from a high voltage level to a low voltage level, resulting in transistor Q4 being turned “off”.

For example, in one exemplary embodiment, if a first switch within manual switches 80 is closed, the resistance (5 kilo-ohms) seen by oscillator 78 results in a frequency being generated by oscillator 78 such that counter 84 will place provide a high voltage signal to SR latch 77 approximately one hour after power was initially provided to bright white LEDs 64a-64l. If a second switch within manual switches 80 is closed, the resistance (10 kilo-ohms) seen by oscillator 78 results in a frequency being generated by oscillator 78 such that counter 84 will provide a high voltage signal to SR latch 77 two hours after power was initially provided to bright white LEDs 64a-64l. In this way, a user can determine how long bright white LEDs should remain “on” after initially being activated by a loss of light condition. In other embodiments, shorter or longer lengths of time may be implemented by timer circuitry 74.

The present invention describes a system and apparatus for illuminating real estate signs without the use of traditional AC or wall outlet power. Although the present invention has been described with reference to preferred embodiments, workers skilled in the art will recognize that changes may be made in form and detail without departing from the spirit and scope of the invention.

1. A real estate sign lighting system, comprising:
a real estate sign hood removably attached to a horizontal beam of a real estate post;
a housing mountable on a portion of the real estate sign hood;
bright white light emitting diodes (LEDs) connected to the real estate sign hood and positioned to illuminate a real estate sign connected to the horizontal beam of the real estate post; and
a power supply system for providing power to the bright white LEDs.

2. The real estate sign lighting system of claim 1, wherein the power supply system comprises:
solar panels affixed to a top portion of the housing;
at least one battery located within the housing and electrically connected to receive charging power from the solar panels and to provide power to the bright white LEDs;
a light sensor;
control circuitry located within the housing and operatively connected to the light sensor, wherein the control circuitry selectively supplies power from the at least one battery to the bright white LEDs based on input from the light sensor.

3. The real estate sign lighting system of claim 2, wherein the control circuitry includes:
a switching circuit operatively connected between the at least one battery and the bright white LEDs and receiving input from the light sensor, wherein when light is detected by the light sensor, the switching circuit is in a first state that prevents power from flowing between the at least one battery to the bright white LEDs and wherein when a diminished light level is detected by the light sensor, the switching circuit is in a second state that allows power to flow from the at least one battery to the bright white LEDs; and
an adjustable timer circuit operatively connected to the switching circuit that places the switching circuit in the first state a determined amount of time after the switching circuit is initially placed in the second state by the adjustable light sensor.

4. The real estate sign lighting system of claim 1, wherein the housing comprises:
a floor;
side walls surrounding the floor; and
a roof pivotally connected to one of the side walls, allowing the roof to be lifted to expose an open interior portion of the housing defined by the floor and the sidewalls;

5. The real estate sign lighting system of claim 1, wherein the real estate sign hood comprises:
a channel configured to fit over a horizontal beam of the real estate post;
side portions located on either side of the channel for supporting the bright white LEDs; and
means for securing the housing to the real estate sign hood.

6. The real estate sign lighting system of claim 2, further comprising:
a battery compartment mountable on the real estate sign hood having a base structure for receiving and securing the at least one battery.

7. A lighting system for real estate signs, the system comprising:
a base configured to fit over a horizontal bar of a real estate sign;
a housing mountable on the base;
batteries located within the housing;
bright white light emitting diodes (LEDs) electrically connected to the batteries and physically positioned along the base to illuminate the real estate sign, wherein the batteries supply power to the bright white LEDs; and
control circuitry located within the housing and electrically connected to the batteries for selectively controlling when energy is supplied from the batteries to the bright white LEDs.

8. The lighting system of claim 7, wherein the housing includes:
four sidewalls; and
a roof pivotally connected to one of the side walls, allowing the roof to be lifted up to expose an open area within the housing.

9. The lighting system of claim 8, further including:
solar panels secured to the housing and electrically connected to the batteries, wherein the solar panels generate electricity used to charge the batteries.

10. The lighting system of claim 9, wherein the solar panels are secured to the top side of the housing.

11. The lighting system of claim 7, wherein the control circuitry comprises:
a photocell for detecting low-light conditions;
a timer connected to the photocell
a switch connected to the timer, wherein when the photocell detects a low-light condition, the timer opens the switch allowing power to be supplied to the bright white LEDs for a set amount of time.

12. The lighting system of claim 7, wherein the batteries are sealed lead-acid batteries.

13. An autonomous lighting system for a real estate signs, the system comprising:
a real estate sign hood configured to fit over a horizontal beam of the real estate pole;
means for illuminating the real estate sign, wherein the means for illuminating the real estate sign is mounted on the real estate sign hood;
means for generating power;
means for storing power generated by the means for generating power;
means for controlling the distribution of power from the means for storing power to the means for illuminating the real estate sign; and
a housing mounted on the real estate sign hood that encloses the means for storing power and the means for controlling distribution of power, and supports the means for generated power.

14. The autonomous lighting system of claim 13, wherein the means for illuminating the real estate sign includes bright white light emitting diodes.

15. The autonomous lighting system of claim 13, wherein the means for generating power includes solar panels mounted on a top surface of the housing.

16. The autonomous lighting system of claim 13, wherein the means for storing power includes at least one rechargeable batter.

17. The autonomous lighting system of claim 13, wherein the means for controlling the distribution of power includes:
a light sensor for detecting light levels;
a switching circuit having a first state and a second state, wherein when the light sensor detects a loss of light then the switching circuit is placed in the second state, which allows power to flow from the means for storing power to the means for illuminating the real estate sign;
a timer circuit having switches allowing the timer circuit to be set by a user for a designated amount of time, wherein when the designated amount of time has passed following the switching circuit being placed in the second state by the light sensor, the timer circuit places the switching circuit back into the first state, which prevents power from flowing from the means for storing power to the means for illuminating the real estate sign.

18. The autonomous lighting system of claim 13, wherein the housing includes means for pivoting a roof of the housing to expose an open interior portion of the housing.
